(19) United States
(12) Patent Application Publication
(10) Pub. No.: US 2016/0117833 A1
(43) Pub. Date: Apr. 28, 2016

(54) ONLINE BACKGROUND MODEL EXTRACTION

(71) Applicant: AGT International GmbH, Zurich (CH)

(72) Inventors: Stephan KRAUSS, Kaiserslautern (DE); Jan HIRZEL, Kaiserslautern (DE); Pablo ABAD, Schweinfurt (DE); Didier STRICKER, Kaiserslautern (DE); Henning HAMER, Darmstadt (DE); Markus SCHLATTMANN, Darmstadt (DE)

(21) Appl. No.: 14/919,734

(22) Filed: Oct. 22, 2015

Related U.S. Application Data
(60) Provisional application No. 62/067,687, filed on Oct. 23, 2014.

(51) Int. Cl. G06T 7/00; G06K 9/46

(52) U.S. Cl. CPC G06T 7/0081; G06K 9/4604

(57) ABSTRACT

Apparatus and method for extracting a background model from a video stream of frames. Each frame is divided into a rectangular array of blocks, and a block descriptor of each block is compared with the previous frame's corresponding block descriptor. When a block descriptor is substantially the same as the corresponding block descriptor of the preceding frame for at least a predetermined number of frames, then the background model is updated according to the block descriptor.

### CROSS REFERENCE TO RELATED APPLICATIONS

This application claims the benefit of U.S. provisional Application No. 62/067,687 filed on Oct. 23, 2014 which is hereby incorporated by reference in their entirety.

### BACKGROUND

In video analytics, it is important to distinguish video foreground imagery (e.g., moving objects of interest) from video background (e.g., static parts of the image). Various methods for distinguishing foreground from background currently exist, but they lack the ability to accurately and quickly compute the background in dynamic scenes containing textured and non-textured objects (e.g. illumination changes, camera movement, changes to the scene, etc.). This is especially important in real-time online applications, where on-demand availability of an accurate background-model is necessary. This is not provided by current solutions.

It would therefore be desirable and advantageous to have a method for real-time online extraction of a background model from a video stream. This goal is attained by embodiments of the present invention.

### SUMMARY

Embodiments of the present invention provide methods for analyzing a stream of video frames to differentiate foreground imagery from background imagery in real-time for immediate online use. In certain embodiments, the method yields results which are incrementally improved with each new frame processed.

Therefore, according to an embodiment of the present invention there is provided an apparatus for extracting a background model from a video stream of frames, the apparatus including: (a) a non-transitory data storage device, for storing data and executable program code; (b) a processor implementing: (c) a background model; (d) a block descriptor computer, for dividing a frame into a rectangular array of blocks, and for computing a block descriptor of a block; (e) a block descriptor of a current frame of the video stream; (f) a block descriptor of a previous frame of the video stream; (g) a match detector, for determining if a block descriptor of the current frame is substantially the same as a block descriptor of the previous frame; (h) a staging cache for storing block descriptors; and (i) an updater, for updating the background model according to a block descriptor in the staging cache.

In addition, according to another embodiment of the present invention, there is provided a method for using a data processor to extract a background model from a video stream of frames in a non-transitory memory, the method including: (a) obtaining, by the data processor, a frame from the video stream; (b) dividing, by the data processor, the frame into a rectangular array of blocks; (c) for each block in the rectangular array: (d) computing, by the data processor, a current block descriptor of the block; (e) if a corresponding block retrieved from the background model has a block descriptor that does not substantially match the current block descriptor, then: (f) if the corresponding block of the previous frame has a block descriptor that does substantially match the current block descriptor, and has matched the current block descriptor for at least a predetermined number of frames, then putting the current block descriptor into a staging cache in the non-transitory memory; and (g) updating, by the data processor, the background model according to a block descriptor selected from the staging cache.

Moreover, according to yet another embodiment of the present invention, there is provided a computer product including executable code instructions in a non-transitory storage device, which instructions, when executed by a data processor, cause the data processor to perform a method for extracting a background model from a video stream of frames in a non-transitory memory, the method including: (a) obtaining, by the data processor, a frame from the video stream; (b) dividing, by the data processor, the frame into a rectangular array of blocks; (c) for each block in the rectangular array: (d) computing, by the data processor, a current block descriptor of the block; (e) if a corresponding block retrieved from the background model has a block descriptor that does not substantially match the current block descriptor, then: (f) if the corresponding block of the previous frame has a block descriptor that does substantially match the current block descriptor, and has matched the current block descriptor for at least a predetermined number of frames, then putting the current block descriptor into a staging cache in the non-transitory memory; and (g) updating, by the data processor, the background model according to a block descriptor selected from the staging cache.

### BRIEF DESCRIPTION OF THE DRAWINGS

The subject matter disclosed may best be understood by reference to the following detailed description when read with the accompanying drawings in which:

FIG. 1 illustrates a video image stream and images therefrom, and a conceptual block diagram of a system for background extraction therefrom, according to an embodiment of the present invention.

FIG. 2A illustrates a schema for a background model data structure according to an embodiment of the present invention.

FIG. 2B illustrates a schema for an image block descriptor according to an embodiment of the present invention.

FIG. 3 is a flowchart of a method for background model extraction according to an embodiment of the present invention.

For simplicity and clarity of illustration, elements shown in the figures are not necessarily drawn to scale, and the dimensions of some elements may be exaggerated relative to other elements. In addition, reference numerals may be repeated among the figures to indicate corresponding or analogous elements.

### DETAILED DESCRIPTION

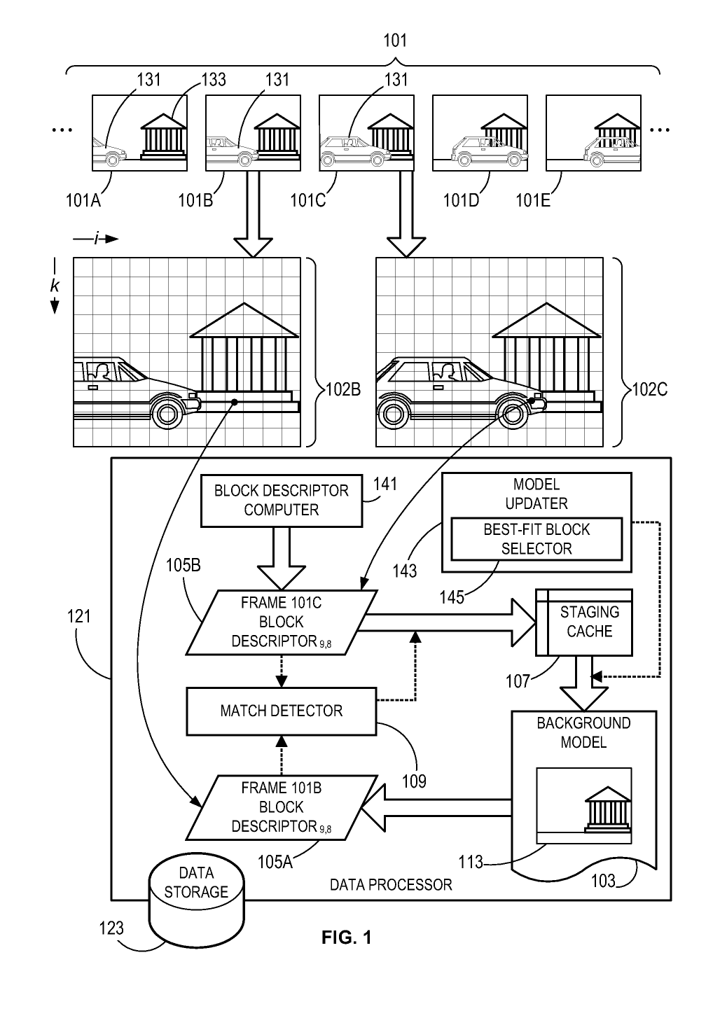

FIG. 1 illustrates a video image stream 101 containing exemplary frames 101A, 101B, 101C, 101D, and 101E showing an object of interest 131 (a vehicle 131) moving in the foreground in front of a background scene 133 (a street and building 133). According to various embodiments of the present invention, a frame is divided into a rectangular array of “image blocks” (also referred to herein as “blocks”), as illustrated for frame 101B divided into rectangular array 102B, and for frame 101C divided into rectangular array 102C. In various embodiments, blocks within an array are indexed by their horizontal position i (left-to-right column number) and their vertical position k (top-to-bottom row number) as shown (wherein the starting index is 1). According to certain embodiments, an image block is described by a “block descriptor”, which contains information for reconstructing the portion of the frame image in the block. In a related embodiment, a block descriptor contains data formatted in compliance with a typical graphical image data format standard.

An embodiment of the invention provides a data processor 121 containing a non-transitory data storage unit 123 for maintaining data and executable program code for the following elements: a block descriptor computer module 141, for dividing a frame into a rectangular array of blocks and for computing a block descriptor of a block; a block descriptor 105A of block i=9, k=8 of frame 101B; a block descriptor 105B of block i=9, k=8 of frame 101C; a staging cache area 107 in data storage 123, a background model 103 representing a background image 113, and a match detector module 109, for detecting the condition where a current block descriptor (such as block descriptor 105B) represents substantially the same image block as that of the immediately-preceding block descriptor (such as block descriptor 105A). Match detector module 109 also detects the condition where the current block descriptor is not substantially the same as that of the immediately-preceding block descriptor. In various embodiments, a match between two blocks is determined according to normalized cross-correlation and the mean of absolute differences. In a related embodiment, the mean of absolute differences is compensated for the mean difference.

According to an embodiment of the present invention, the various components and modules described and illustrated herein are implemented by data processor 121 via executable code contained in non-transitory storage unit 123.

Frame 101C immediately follows frame 101B in video stream 101, and according to this embodiment, in this particular non-limiting example the blocks of frame 101C are compared with the corresponding blocks of frame 101B to detect changes. In this non-limiting example match detection module 109 compares block descriptor i=9, k=8 of frame 101C with block descriptor i=9, k=8 of frame 101B to determine if there is substantially the same image fragment in the block at i=9, k=8. In this example, the block at i=9, k=8 will not be substantially the same, because the object of interest, vehicle 131, has moved in relation to the background scene, street and building 133.

If a block descriptor in the current frame matches the corresponding block descriptor in the background model, then the block descriptor of the background model is updated directly using the block descriptor of the current frame. If a block descriptor in the current frame does not match the corresponding block descriptor of the background model but is substantially the same as the corresponding block descriptor of the previous frame, then the current block descriptor is placed in staging cache 107, which contains candidate blocks for updating background model 103. If the block descriptor in staging cache 107 matches the corresponding block descriptor of the current frame for at least a predetermined number of frames, then an updater module 143 updates background model 103 according to the block descriptor, by putting the block descriptor into the corresponding block of background model 103. In various embodiments, updater module 143 contains a best-fit block selector module 145 to select a candidate block from staging cache 107 which best fits into the local environment (the immediate neighbors of the block). In a related embodiment, the quality of the local fit is computed by best-fit block selector module 145 based on spectral response intensities and the degree of discontinuity between neighboring blocks, where the solution is found according to the known Iterated Conditional Modes (ICM) algorithm.

By analyzing the changes of the image blocks as described in detail herein below, apparatus according to these embodiments of the present invention extract background image 113 from video stream 101.

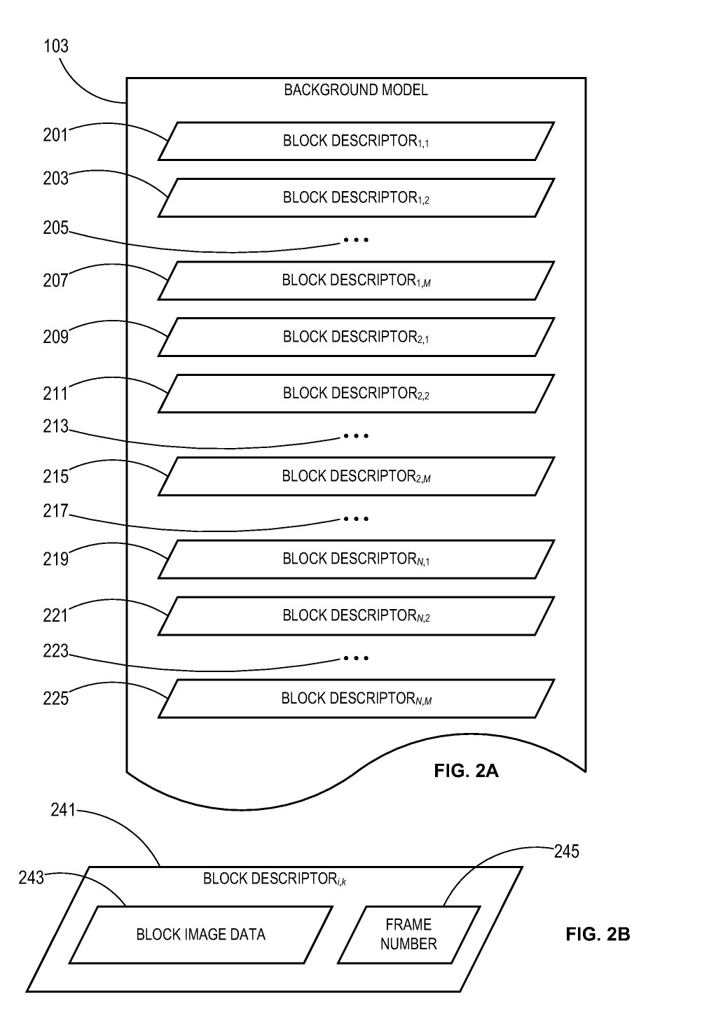

FIG. 2A illustrates a general data structure for background model 103, according to an embodiment of the present invention. Block descriptors 201, 203, and 207 represent block descriptors in the first column of an N×M array, with ellipsis 205 indicating that additional block descriptors from 2 to Min the first column are not shown. Block descriptors 209, 211, and 215 represent block descriptors in the second column of the N×M array, with ellipsis 213 indicating that additional block descriptors from 2 to M in the second column are not shown. And block descriptors 219, 221, and 225 represent block descriptors in the Nth column of the N×M array, with ellipsis 223 indicating that additional block descriptors from 2 to M in the Nth column are not shown, and ellipsis 217 indicating that block descriptors for columns 3 through N are not shown.

FIG. 2B illustrates a general data structure for a block descriptor 241 according to a related embodiment of the present invention. Block descriptor 241 is indexed by i and k and contains block image data 243 in compliance with a typical graphical image data format standard. Block descriptor 241 also contains a frame number 245 indicating the number of frames for which the block description did substantially match the corresponding block of the frames from the video stream.

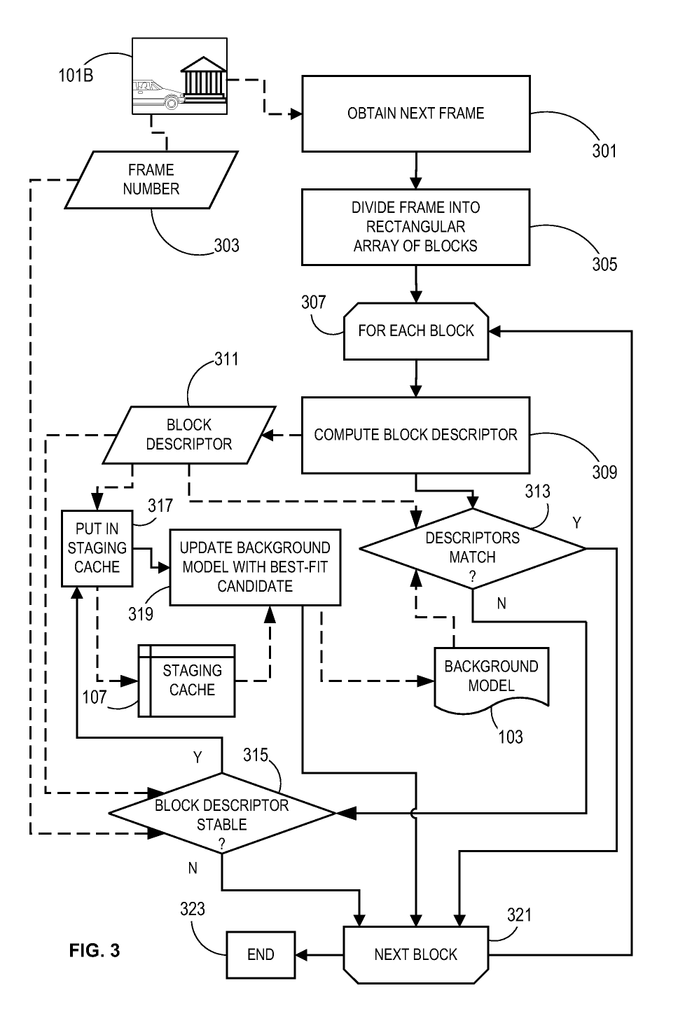

FIG. 3 is a flowchart of a method for using a data processor (such as data processor 121 in FIG. 1) to extract a background model according to an embodiment of the present invention. A step 301 obtains next frame 101B. In a step 305, frame 101B is divided into a rectangular array of blocks. At a start of a loop 307, for each block: a step 309 computes a block descriptor 311, which is input into a decision point 313. A block descriptor is retrieved from background model 103. If the block descriptors do substantially match, then the corresponding block in background model 103 is updated directly with the block from the current frame. If the block descriptors do not substantially match, then at a decision point 315 if block descriptor 311 is stable over at least a predetermined number of frames (i.e., if the block descriptors have substantially matched over the at least the predetermined number of frames), then in a step 317 block descriptor 311 is put into staging cache 107. The determination of the number of frames over which the block descriptors have substantially matched is made according to a frame number 303 of a block descriptor from the current frame. The frame number of the current block descriptor 311 is one plus the value of the corresponding block descriptor of the previous frame if the both match and zero otherwise. In a step 319, background model 103 is updated with the best-fit candidate in staging cache 107 (i.e., the best-fit block descriptor is put into background model 103). In certain embodiments of the invention, the best-fit among all possible candidates in staging cache 107 is the one which best fits into the local environment (the block that best fits its immediate neighbors). In a related embodiment, the quality of the local fit is computed based on spectral response intensities and the degree of discontinuity between neighboring blocks, where the solution is found according to the ICM algorithm.

The loop continues at an end of loop 321. If there are more blocks, the loop is repeated. Otherwise, the method terminates at and end-point 323.

According to a related embodiment of the present invention, in the case of the first frame of video stream 101, there is no previous frame, and therefore each block is put into staging cache 107 by step 315, and background model 103 is initialized with the blocks of the first frame.

In addition, according to a further embodiment of the present invention, there is provided a computer product including executable code instructions in a non-transitory storage device, which instructions, when executed by a processor, cause the processor to perform a method according to an embodiment of the present invention.

What is claimed is:

1. An apparatus for extracting a background model from a video stream of frames, the apparatus comprising:
a non-transitory data storage device, for storing data and executable program code;
a processor implementing:
a background model;
a block descriptor computer, for dividing a frame into a rectangular array of blocks, and for computing a block descriptor of a block;
a block descriptor of a current frame of the video stream;
a block descriptor of a previous frame of the video stream;
a match detector, for determining if two block descriptors are substantially the same;
a staging cache for storing block descriptors; and
an updater, for updating the background model according to a block descriptor in the staging cache.

2. The apparatus of claim 1, further comprising a best-fit block selector, for selecting the block descriptor in the staging cache.

3. The apparatus of claim 2, wherein the best-fit block selector is contained within the updater.

4. The apparatus of claim 2, wherein the best-fit block selector determines a quality of local fit according to a selection from a group consisting of: a spectral response intensity; and a degree of discontinuity between neighboring blocks.

5. The apparatus of claim 2, wherein the best-fit block selector determines a quality of local fit according to an Iterated Conditional Modes algorithm.

6. The apparatus of claim 1, wherein the match detector determines whether two blocks are substantially the same according to a selection from a group consisting of: a normalized cross correlation; a mean of absolute differences; and a mean difference.

7. A method for using a data processor to extract a background model from a video stream of frames in a non-transitory memory, the method comprising:
obtaining, by the data processor, a frame from the video stream;
dividing, by the data processor, the frame into a rectangular array of blocks;
for each block in the rectangular array:
computing, by the data processor, a current block descriptor of the block;
if a corresponding block retrieved from the background model has a block descriptor that does substantially match the current block descriptor, then:
update the block descriptor of the background model directly using the current block descriptor else:
if the corresponding block retrieved from the previous frame has a block descriptor that does substantially match the current block descriptor, and has matched the current block descriptor for at least a predetermined number of frames, then putting the current block descriptor into a staging cache in the non-transitory memory; and
updating, by the data processor, the background model according to a block descriptor selected from the staging cache.

8. The method of claim 7, further comprising selecting the block descriptor from the staging cache according to a best fit of the block to the immediate neighbors thereof.

9. The method of claim 8, wherein the best fit of the block is determined according to a selection from a group consisting of: a spectral response intensity; and a degree of discontinuity between neighboring blocks.

10. The method of claim 8, wherein the best fit of the block is determined according to an Iterated Conditional Modes algorithm.

11. The method of claim 7, wherein if a corresponding block retrieved from the background model has a block descriptor that does not substantially match the current block descriptor is determined according to a selection from a group consisting of: a normalized cross correlation; a mean of absolute differences; and a mean difference.

12. A computer product comprising executable code instructions in a non-transitory storage device, which instructions, when executed by a data processor, cause the data processor to perform a method for extracting a background model from a video stream of frames in a non-transitory memory, the method comprising:
obtaining, by the data processor, a frame from the video stream;
dividing, by the data processor, the frame into a rectangular array of blocks;
for each block in the rectangular array:
computing, by the data processor, a current block descriptor of the block;
if a corresponding block retrieved from the background model has a block descriptor that does substantially match the current block descriptor, then:
update the block descriptor of the background model directly using the current block descriptor else:
if the corresponding block retrieved from the previous frame has a block descriptor that does substantially match the current block descriptor, and has matched the current block descriptor for at least a predetermined number of frames, then putting the current block descriptor into a staging cache in the non-transitory memory; and
updating, by the data processor, the background model according to a block descriptor selected from the staging cache.

13. The computer product of claim 12, wherein the method executed by the data processor further comprises selecting the block descriptor from the staging cache according to a best fit of the block to the immediate neighbors thereof.

14. The computer product of claim 13, wherein the best fit of the block is determined according to a selection from a group consisting of: a spectral response intensity; and a degree of discontinuity between neighboring blocks.

15. The computer product of claim 13, wherein the best fit of the block is determined according to an Iterated Conditional Modes algorithm.

16. The computer product of claim 12, wherein if the corresponding block retrieved from the background model has a block descriptor that does substantially match the current block descriptor is determined according to a selection from a group consisting of: a normalized cross correlation; a mean of absolute differences; and a mean difference.
